(19) United States
(12) Patent Application Publication
(10) Pub. No.: US 2007/0175996 A1
(43) Pub. Date: Aug. 2, 2007

(54) Imaging reader and method with tall field of view

(76) Inventors: Edward Barkan, Miller Place, NY (US); Mark Dryzmala, Commack, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/342,932

(22) Filed: Jan. 30, 2006

(51) Int. Cl. G06K 7/10

(52) U.S. Cl. 235/454; 235/462.41

(57) ABSTRACT

A target is illuminated with light for image capture by a solid-state imager of an imaging reader over a tall field of view having an aspect ratio whose vertical dimension is larger than its horizontal dimension during image capture.

### BACKGROUND OF THE INVENTION

1. Field of the Invention

The present invention generally relates to an electro-optical reader for reading indicia, especially two-dimensional indicia, by using a solid-state imager for image capture over a field of view having an aspect ratio whose vertical dimension is larger than its horizontal dimension.

2. Description of the Related Art

Flat bed laser readers, also known as horizontal slot scanners, have been used to electro-optically read one-dimensional bar code symbols, particularly of the Universal Product Code (UPC) type, at a point-of-transaction workstation in supermarkets, warehouse clubs, department stores, and other kinds of retailers for many years. As exemplified by U.S. Pat. No. 5,059,779; No. 5,124,539; and No. 5,200,599, a single, horizontal window is set flush with, and built into, a horizontal countertop of the workstation. Products to be purchased bear an identifying symbol and are typically slid or swiped across the horizontal window through which a multitude of scan lines is projected in a generally upwards direction. When at least one of the scan lines sweeps over a symbol associated with a product, the symbol is processed and read.

The multitude of scan lines is generated by a scan pattern generator which includes a laser for emitting a laser beam at a mirrored component mounted on a shaft for rotation by a motor about an axis. A plurality of stationary mirrors is arranged about the axis. As the mirrored component turns, the laser beam is successively reflected onto the stationary mirrors for reflection therefrom through the horizontal window as a scan pattern of the scan lines.

Instead of, or in addition to, a horizontal slot scanner, it is known to provide a vertical slot scanner, which is typically a portable reader placed on the countertop such that its window is generally vertical and faces an operator at the workstation. The generally vertical window is oriented perpendicularly to the horizontal window, or is slightly rearwardly inclined. The scan pattern generator within the workstation also projects the multitude of scan lines in a generally outward direction through the vertical window toward the operator. The generator for the vertical window can be the same as or different from the generator for the horizontal window. The operator slides or swipes the products past either window from right to left, or from left to right, in a “swipe” mode. Alternatively, the operator merely presents the symbol on the product to the center of either window in a “presentation” mode. The choice depends on operator preference or on the layout of the workstation.

Each product must be oriented by the operator with the symbol facing away from the operator and directly towards either window. Hence, the operator cannot see exactly where the symbol is during scanning. In typical “blind-aiming” usage, it is not uncommon for the operator to repeatedly swipe or present a single symbol several times before the symbol is successfully read, thereby slowing down transaction processing and reducing productivity.

The blind-aiming of the symbol is made more difficult because the position and orientation of the symbol are variable. The symbol may be located low or high, or right or left, on the product, or anywhere in between. The symbol may be oriented in a “picket fence” orientation in which the elongated parallel bars of the one-dimensional UPC symbol are vertical, or in a “ladder” orientation in which the symbol bars are horizontal, or at any orientation angle in between.

These point-of-transaction workstations have been long used for processing transactions involving products associated with one-dimensional symbols each having a row of bars and spaces spaced apart along one direction, and recently used for processing two-dimensional symbols, such as Code 49, as well. Code 49 introduced the concept of vertically stacking a plurality of rows of bar and space patterns in a single symbol. The structure of Code 49 is described in U.S. Pat. No. 4,794,239. Another two-dimensional code structure for increasing the amount of data that can be represented or stored on a given amount of surface area is known as PDF417 and is described in U.S. Pat. No. 5,304,786. Such two-dimensional symbols are generally read by electro-optical readers operative for projecting a laser beam as a raster of scan lines, each line extending in one direction over a respective row, and all the lines being spaced apart along a height of the two-dimensional symbol in a generally perpendicular direction.

Both one- and two-dimensional symbols can also be read by employing solid-state imagers. For example, an image sensor device may be employed which has a one- or two-dimensional array of cells or photosensors, which correspond to image elements or pixels in a field of view of the device. Such an image sensor device may include a one- or two-dimensional charge coupled device (CCD) or a complementary metal oxide semiconductor (CMOS) device and associated circuits for producing electronic signals corresponding to a one- or two- dimensional array of pixel information over a field of view. In addition to the aforementioned symbols, scanners employing image sensor devices can also read general two-dimensional symbols, such as DataMatrix, which cannot be read by existing laser-based scanners.

It is therefore known to use a solid-state device for capturing a monochrome image of a symbol as, for example, disclosed in U.S. Pat. No. 5,703,349. It is also known to use a solid-state device with multiple buried channels for capturing a full color image of a target as, for example, disclosed in U.S. Pat. No. 4,613,895. It is common to provide a two-dimensional CCD with a 640×480 resolution commonly found in VGA monitors, although other resolution sizes are possible.

Thus, the known point-of-transaction workstations utilize solid-state imagers for capturing images of two-dimensional targets, especially two-dimensional symbols required to be electro-optically read, over a field of view that has the same aspect ratio as a conventional television picture, namely that its horizontal dimension is larger than its vertical dimension.

Although generally satisfactory for its intended purpose, this particular orientation of the field of view has some disadvantages. For example, the window through which the light is captured is made more wide than high to accommodate the greater horizontal dimension of the field of view and this, in turn, causes the housing of the reader to be made wider, as considered from side-to-side. Such a wide housing is not easy to grasp and pick up with one hand in order to read a symbol on a product that cannot easily be brought to the reader. Another disadvantage of a wide and short field of view is that some symbols, especially on tall products, may be positioned partially or fully above or below the window and may miss being read through the window during either the presentation or the swipe mode, and fail to be read.

### SUMMARY OF THE INVENTION

### Objects of the Invention

Accordingly, it is a general object of this invention is to advance the state of the art of electro-optical readers that operate by image capture.

Another object of this invention is to reliably capture an image of a target over a tall field of view having an aspect ratio whose vertical dimension is greater than its horizontal dimension.

Still another object of the present invention is to enable a user to easily grasp and pick up with one hand a narrow housing reader to capture images of targets that cannot easily be brought to the reader.

### Features of the Invention

In keeping with the above objects and others, which will become apparent hereinafter, one feature of the present invention resides, briefly stated, in a reader for electro-optically reading a target, especially one-dimensional symbols, two-dimensional symbols, or documents. The reader is preferably embodied as a portable point-of-transaction workstation having a window, but could be embodied as a handheld reader having a window. During reading, the symbol is swiped past the window during a swipe mode, or is presented to the window of the reader during a presentation mode. In the preferred embodiment, the workstation is installed in a retail establishment, such as a supermarket, but can be installed virtually anywhere requiring targets to be read.

The window is preferably a sheet of light-transmissive plastic or glass, and its primary function is to keep dust and like contaminants out of the housing. The window need not be positioned at the front or nose of the housing, but may be deeply recessed within the housing well away from the nose to minimize reflections at the window, thereby leaving a bare opening or aperture at the nose of the housing. The window need not be in a vertical plane, but can be oriented at any angle relative to the nose of the housing. For these reasons, the window is sometimes referred to herein as a “scanning aperture” or as a “presentation area”.

A two-dimensional, solid-state imager is mounted in the reader, and includes an array of image sensors operative for capturing light from a one-dimensional and/or a two-dimensional target passing through the presentation area over a field of view during the reading. Preferably, the array is a CCD array, but could be a CMOS array. The imager may be associated with a high-speed strobe illuminator under control of a controller to enable the image of the target to be acquired in a very short period of time, for example, on the order of 500 microseconds, so that the target image is not blurred even if there is relative motion between the imager and the target. The strobe illumination is preferably brighter than ambient illumination, especially close to the presentation area. The illumination can also be continuous. The imager captures light over an exposure time period, also under the control of the controller. A short exposure time also prevents image blurring.

As noted above, the conventional imager of the prior art is mounted in an imaging reader so that its field of view has the same aspect ratio as a conventional television picture, namely, that its horizontal dimension is larger than its vertical dimension. In accordance with this invention, the solid-state imager is rotated 90 degrees around its optical axis and mounted in this orientation so that its field of view is tall, namely, that its vertical dimension is larger than its horizontal dimension.

Ideally, the housing of an imaging reader should be narrow enough for a user to easily pick it up to read large, heavy, or bulky products that cannot easily be brought to the reader. Rotating the solid-state imager allows the housing to be designed with a window of narrow width that in turn, allows the housing itself to be configured with a narrow width, thereby enabling easy handling.

Another advantage of a tall field of view, which is created by rotating the solid-state imager, stems from how the product is swiped. During the swipe mode, the user swipes the product bearing the symbol in a horizontal motion across the presentation area. As noted above, the symbol faces away from the user and, as a result of this blind aiming, some symbols fail to be read because they are not registered in the presentation area. Increasing the vertical height of the presentation area to accommodate a tall field of view reduces the chance of such reading failure, especially for elongated products where the symbol is positioned partially or fully above or below the presentation area during the swiping motion.

There is a group of documents such as driver's licenses, customer loyalty cards, membership cards, cash register paper receipts, credit/debit card transaction receipts requiring customer signatures, etc. that often are desired to be imaged as part of a point-of sale transaction, regardless of whether they bear a symbol. The image of each such document is captured by the solid-state imager by positioning each such document at the presentation area of the reader. A tall field of view and a tall window make it especially convenient to capture the entire image of each such document. A guide can be mounted at the front of the reader at the presentation area to make it easy to position each such document at the presentation area. Preferably, the guide is upwardly open along the vertical direction to enable easy insertion and removal of each such document along the vertical direction.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a point-of-transaction workstation operative for capturing light from two-dimensional targets in accordance with the prior art;

FIG. 2 is a schematic block diagram of various components of an imaging reader used in the workstation of FIG. 1 in accordance with the prior art;

FIG. 3 is a schematic representation of the shape of the field of view of the imager used in the reader of FIG. 2;

FIG. 4 is a schematic block diagram of various components of an imaging reader in accordance with the present invention;

FIG. 5 is a schematic representation of the shape of the field of view of the imager used in the reader of FIG. 4; and

FIG. 6 is a perspective view of a practical implementation of an imaging reader in accordance with the present invention.

### DETAILED DESCRIPTION OF THE PREFERRED EMBODIMENTS

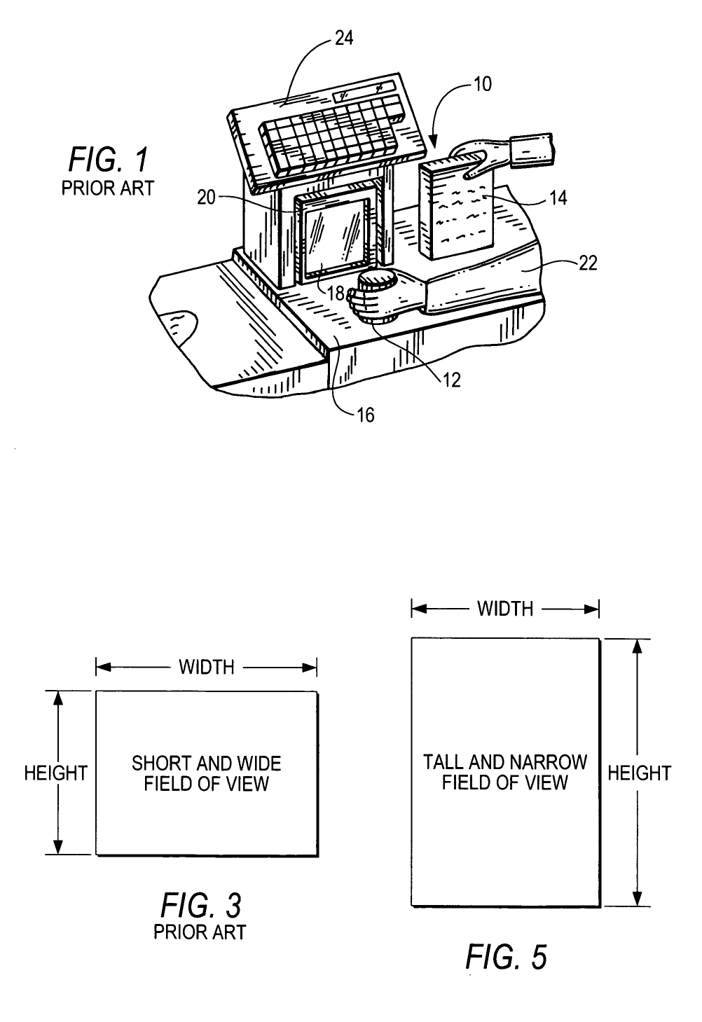

Reference numeral 10 in FIG. 1 generally identifies a workstation in accordance with the prior art for processing transactions and specifically a checkout counter at a retail site at which products, such as a can 12 or a box 14, each bearing a target symbol, are processed for purchase. The counter includes a countertop 16 across which the products are slid at a swipe speed past a vertical window 18 of a box-shaped vertical slot reader 20 mounted on the countertop 16. A checkout clerk or operator 22 is located at one side of the countertop, and the reader 20 is located at the opposite side. A cash/credit register 24 is located within easy reach of the operator.

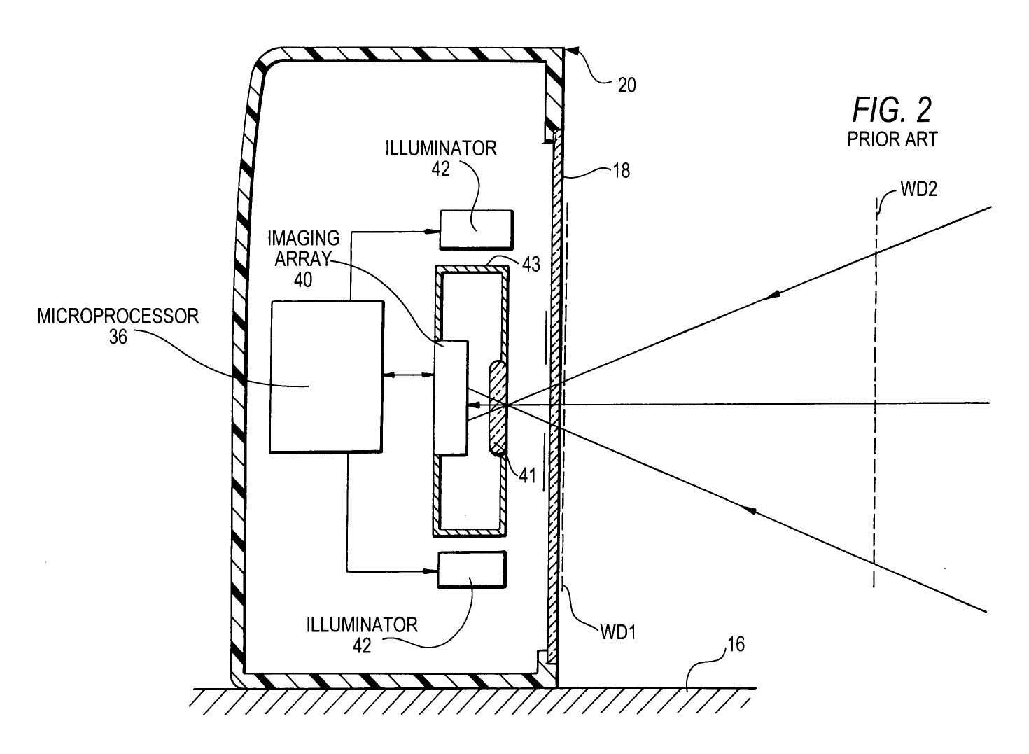

As shown in FIG. 2, in further accordance with the prior art, the vertical slot scanner generally includes an imager 40 and a focusing lens 41 mounted in an enclosure 43. The imager 40 is a solid-state device, for example, a CCD or a CMOS imager and has an array of addressable image sensors operative for capturing light through the window 18 from a target over a field of view and located in a working range of distances between a close-in working distance (WD1) and a far-out working distance (WD2). Typically, WD1 is about two inches from the imager array 40 and generally coincides with the window 18, and WD2 is about eight inches from the window 18. An illuminator 42 is also mounted in the reader and preferably includes a plurality of light sources, e.g., light emitting diodes (LEDs) arranged around the imager 40 to uniformly illuminate the target.

As also shown in FIG. 2, the area imager 40 and the illuminator 42 are operatively connected to a controller or microprocessor 36 operative for controlling the operation of these components. Preferably, the microprocessor is the same as the one used for decoding light scattered from the indicia and for processing the captured target images.

In operation, the microprocessor 36 sends a command signal to the illuminator 42 to pulse the LEDs for a short time period of 500 microseconds or less, and energizes the area imager 40 to collect light from a target substantially only during said time period. A typical array needs about 33 milliseconds to read the entire target image and operates at a frame rate of about 30 frames per second. The array may have on the order of one million addressable image sensors.

As shown in FIG. 3, the field of view of the prior art imager 40 of FIG. 2, as viewed in a direction perpendicular to the window 18, is generally rectangular and has a greater horizontal dimension (width) than its vertical dimension (height), and has an aspect ratio on the order of 4:3, which corresponds to that of a standard television picture. The field of view can be described as short and wide, and the window 18 has similar dimensions, thereby resulting in the drawbacks described above.

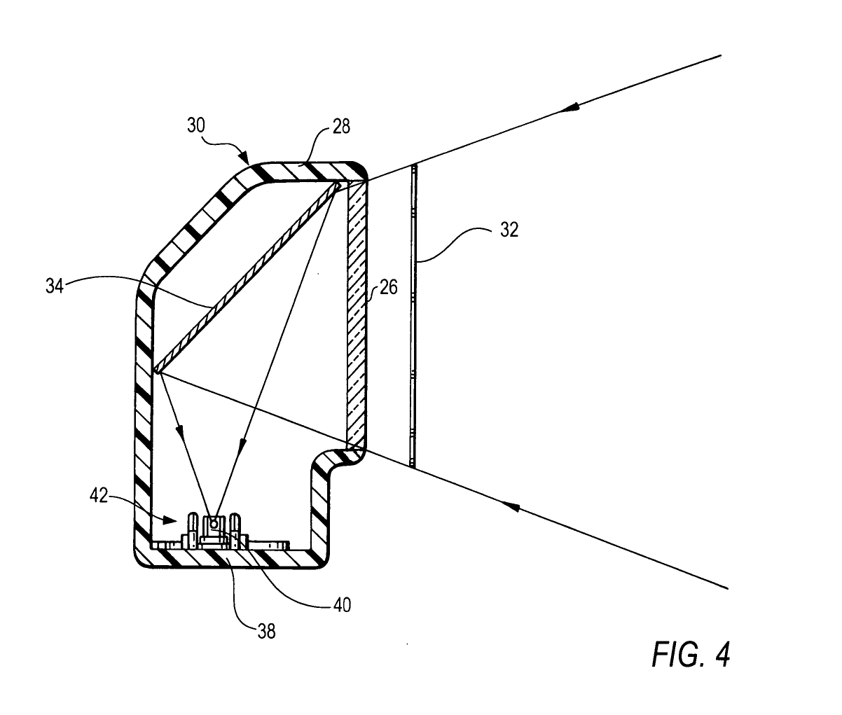

In accordance with this invention, as shown in FIG. 4, the solid-state imager 40 is rotated 90 degrees about its optical axis and mounted within a housing 28 of a reader 30 in which a window (or presentation area) 26 is supported to capture light from a target 32, e.g., a one-dimensional symbol, a two-dimensional symbol, a document, a person, etc. over a field of view. The housing has a base 38 on which the imager 40 is supported, together with the illuminator 42. The imager 40 faces upwardly toward a folding mirror 34 operative for reflecting the captured light to the imager 40, as well as for reflecting the illumination from the illuminator 42 to the target. Positioning the illuminator 42 deep within the housing enables a more uniform illumination of the target, especially up close to the window 26. The folding mirror 34 allows the front-to-back dimension of the housing 28 to be reduced. This minimizes the size of the reader footprint, which is often important in crowded work environments such a retail point-of-sale workstation.

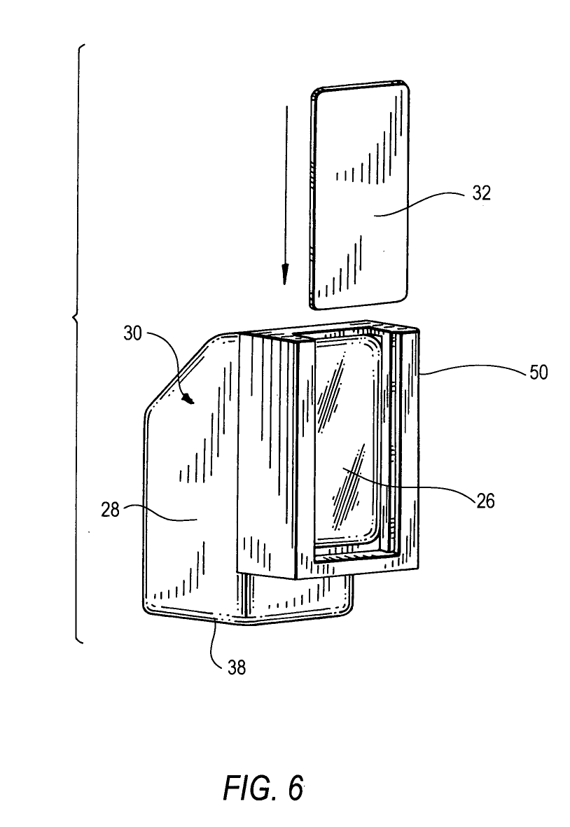

As shown in FIG. 5, the field of view of the rotated imager 40 of FIG. 4, as viewed in a direction perpendicular to the window 26, is generally rectangular and has a greater vertical dimension (height) than its horizontal dimension (width), and has a smaller aspect ratio as compared to that of FIG. 3. The field of view of FIG. 5 can be described as tall and narrow, and the window 26 has similar dimensions (see FIG. 6), thereby resulting in the advantages described above.

As also shown in FIG. 6, an upwardly open guide 50 is mounted in front of the window 26 for receiving the target 32 when it is in sheet form. For example, the target 32 can be a driver's license, and some retailers wish to be able to read the two-dimensional PDF 417 symbol that is printed on the back of many such licenses. This symbol contains such information as the driver's name, address, date of birth, etc., and some retailers wish to capture such information automatically to facilitate automatic population of forms such as credit card applications. A tall field of view enables the entire symbol, or the entire license to be imaged. The guide 50 helps the customer accurately insert, position, and remove the license relative to the window 26. The same guide can be used to read symbols on customer loyalty cards or membership cards.

Another use of the guide is to facilitate signature capture (with or without a rotated imager) on credit card transaction receipts. Rather than capturing one's signature electronically, either by asking the customer to write on a special signature capture pad on which the customer sees his or her signature appear on a display as it is written, or to write on a paper receipt which is placed on a pressure-sensitive pad during the time that the signature is written, the rotated imager of this invention can capture the signature, without using a separate piece of equipment. Thus, the customer would sign the customary paper receipt, which would then be inserted in the guide 50 for image capture.

In variant constructions, the folding mirror 34 can be eliminated where the environment has sufficient front-to-back room to accommodate an increased depth reader. In this case, the imager needs to be positioned far enough back away from the window 26 to allow the field of view to be large enough near the window to see an entire view of the symbol, or the entire surface of the target.

In a broader aspect, the imager need not be rotated, but the imager is still positioned far enough back away from the window 26 (with or without the folding mirror) to allow the field of view to be large enough near the window to see an entire view of the symbol, or the entire surface of the target. Although this embodiment will be wider than for the case of a rotated imager, the guide 50 is still acceptable in some applications for accurate image capture, especially signature capture.

To minimize image blurring, the controller controls how long the LEDs will be energized, whether the energization is continuous or pulsed, the duty cycle of the LEDs, and the intensity of the illumination. In addition, the controller controls the exposure time period of the sensors of the array. The shorter the exposure time period, and the shorter and brighter the illumination of the illuminator, the less likely there will be image blurring even if there is relative motion between the target and the window during reading.

It will be understood that each of the elements described above, or two or more together, also may find a useful application in other types of constructions differing from the types described above. Thus, readers having different configurations can be used.

While the invention has been illustrated and described as orienting a solid-state imager to obtain a tall field of view in an imaging reader, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. A reader for electro-optically reading a target, comprising:
a) a housing having a target presentation area; and
b) a solid-state imager in the housing and including an array of image sensors for capturing light through the presentation area from the target over an exposure time period and over a field of view having an aspect ratio whose vertical dimension is larger than its horizontal dimension during reading.

2. The reader of claim 1; and an illuminator for illuminating the target with illumination light, and a controller for controlling at least one of the illumination light and the exposure time period.

3. The reader of claim 2, wherein the illuminator includes a plurality of light emitting diodes (LEDs).

4. The reader of claim 1, wherein the presentation area lies in a generally vertical plane, and wherein the vertical dimension of the field of view extends generally parallel to the vertical plane of the presentation area.

5. The reader of claim 1, wherein the housing has a base for supporting the reader on a generally planar support surface, and wherein the horizontal dimension of the field of view extends generally parallel to the base.

6. The reader of claim 5, wherein the imager and the illuminator are mounted on the base.

7. The reader of claim 1; and a folding mirror in the housing between front and rear walls thereof, and wherein the imager faces the folding mirror to capture light reflected by the folding mirror.

8. The reader of claim 7; and an illuminator for illuminating the target, and wherein the illuminator includes a plurality of light emitting diodes (LEDs) for emitting light to the folding mirror for reflection therefrom toward the target.

9. The reader of claim 1, wherein the imager is recessed within the housing for a distance sufficient to enable the field of view to cover the entire presentation area.

10. The reader of claim 1; and an illuminator for illuminating the target with illumination light, and wherein the illuminator is recessed within the housing for a distance sufficient to enable the illumination light to uniformly illuminate the target at the presentation area.

11. The reader of claim 1, wherein the target is at least one selected from a group including a one-dimensional symbol, a two-dimensional symbol, and a document.

12. The reader of claim 10, and a guide located in front of the presentation area on the housing, and wherein the target is insertable into, positionable at, and removable from, the guide.

13. The reader of claim 12, wherein the guide has an upwardly open slot through which the target is guided.

14. The reader of claim 1, wherein the imager is one of a charge coupled device and a complementary metal oxide silicon device.

15. A method of electro-optically reading a target, comprising the steps of:
a) positioning a presentation area on a housing of an electro-optical reader; and
b) capturing light with an array of image sensors of a solid-state imager through the presentation area from the target over a field of view having an aspect ratio whose vertical dimension is larger than its horizontal dimension during reading.

16. The method of claim 15, wherein the positioning step is performed by orienting the presentation area in a generally vertical plane, and wherein the vertical dimension of the field of view extends generally parallel to the vertical plane of the presentation area.

17. The method of claim 15; and the step of supporting the reader on a generally planar support surface, and wherein the horizontal dimension of the field of view extends generally parallel to the planar support surface.

18. The method of claim 15; and the step of guiding a target to, and positioning the target at, the presentation area for image capture.

19. The method of claim 15; and the step of selecting the target from a group including a one-dimensional symbol, a two-dimensional symbol, and a document.

20. The method of claim 15, and wherein the capturing step is performed by rotating the imager by 90 degrees about its optical axis, and by fixedly mounting the imager in the housing after such rotation.
